(19) United States
(12) Patent Application Publication
(10) Pub. No.: US 2025/0157002 A1
(43) Pub. Date: May 15, 2025

(54) IMAGE ANALYSIS METHOD AND RELATED SURVEILLANCE APPARATUS

(71) Applicant: VIVOTEK INC., New Taipei City (TW)

(72) Inventor: Chao-Tan Huang, New Taipei City (TW)

(73) Assignee: VIVOTEK INC., New Taipei City (TW)

(21) Appl. No.: 18/943,970

(22) Filed: Nov. 12, 2024

(30) Foreign Application Priority Data
Nov. 13, 2023 (TW) 112143646

(51) Int. Cl. G06T 5/50; G06V 10/774; G06V 20/52; G06V 20/62

(52) U.S. Cl. CPC G06T 5/50; G06V 10/774; G06V 20/52; G06V 20/62

(57) ABSTRACT

An image analysis method performed in a surveillance apparatus having an image receiver and a operation processor is provided. The image analysis method includes the operation processor controlling the image receiver to obtain a plurality of image frames including a first image frame and a second image frame, wherein a definition of a first feature block of the first image frame is different from a definition of a first feature block of the second image frame; and the operation processor taking the first feature block of the first image frame and the first feature block of the second image frame as training samples for training an image analysis model when the operation processor determines the first feature block of the first image frame meets a preset condition. Besides, a related surveillance apparatus is also provided.

### BACKGROUND OF THE INVENTION

### 1. Field of the Invention

The present invention relates to an image analysis method and a related surveillance apparatus, and more specifically, to an image analysis method for increasing image definition (such as sharpness, clarity, level of detail and/or fidelity) or recognition accuracy of an image, and a related surveillance apparatus.

### 2. Description of the Prior Art

In a scenario of long distance, low light and/or fast-moving speed, a conventional surveillance apparatus, e.g., a surveillance camera, often hardly obtains clear images for naked eye recognition or computer recognition due to limitation of hardware capabilities. Therefore, it becomes an important topic in the field to provide an image analysis method capable of generating an accurate recognition result even when an image to be recognized only has a low definition, and a related surveillance apparatus.

### SUMMARY OF THE INVENTION

It is an objective of the present invention to provide an image analysis method for increasing a definition or recognition accuracy of an image, and a related surveillance apparatus for solving the aforementioned problem.

In order to achieve the aforementioned objective, the present invention discloses an image analysis method performed in a surveillance apparatus comprising an image receiver and a operation processor. The image analysis method includes the operation processor controlling the image receiver to obtain a plurality of image frames. The plurality of image frames includes a first image frame and at least one second image frame, each of the first image frame and the at least one second image frame includes a first feature block, and a definition of the first feature block of the first image frame is different from a definition of the first feature block of the at least one second image frame; and the operation processor taking the first feature block of the first image frame and the first feature block of the at least one second image frame as training samples for training an image analysis model when the operation processor determines the first feature block of the first image frame meets a preset condition.

Besides, in order to achieve the aforementioned objective, the present invention further discloses a surveillance apparatus. The surveillance apparatus includes an image receiver and an operation processor. The operation processor is electrically connected to the image receiver. The operation processor is configured to control the image receiver to obtain a plurality of image frames and further configured to take the first feature block of the first image frame and the first feature block of the at least one second image frame as training samples for training an image analysis model when the operation processor determines the first feature block of the first image frame meets a preset condition. The plurality of image frames includes a first image frame and at least one second image frame. Each of the first image frame and the at least one second image frame includes a first feature block, and a definition of the first feature block of the first image frame is different from a definition of the first feature block of the at least one second image frame.

In summary, in the present invention, the operation processor can control the image receiver to obtain the first image frame and the second image frame having the respective first feature blocks, and the operation processor can further take the first feature block of the first image frame and the first feature block of the second image frame as the training samples for training the image analysis model when the operation processor determines the first feature block of the first image frame meets the preset condition. Therefore, when an image to be recognized has a low definition, the present invention can generate an accurate recognition result or sharpen the image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a surveillance apparatus according to a first embodiment of the present invention.

FIG. 2 is a flow chart of an image analysis method according to the first embodiment of the present invention.

FIG. 3 is a diagram of a first image frame obtained by the surveillance apparatus according to the first embodiment of the present invention.

FIG. 4 is a diagram of a second image frame obtained by the surveillance apparatus according to the first embodiment of the present invention.

FIG. 5 is a diagram of a third image frame obtained by the surveillance apparatus according to the first embodiment of the present invention.

FIG. 6 is a diagram of a first image frame and a second image frame obtained by a surveillance apparatus according to a second embodiment of the present invention.

FIG. 7 is a diagram of a first image frame obtained by a surveillance apparatus according to a third embodiment of the present invention.

FIG. 8 is a diagram of a second image frame obtained by a surveillance apparatus according to the third embodiment of the present invention.

FIG. 9 is a diagram of a first image frame obtained by a surveillance apparatus according to a fourth embodiment of the present invention.

FIG. 10 is a diagram of a second image frame obtained by a surveillance apparatus according to the fourth embodiment of the present invention.

### DETAILED DESCRIPTION

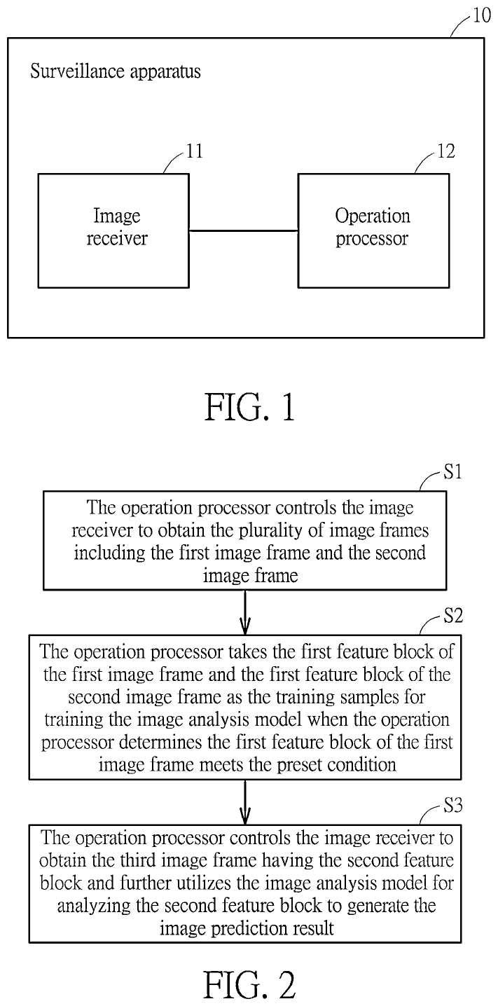

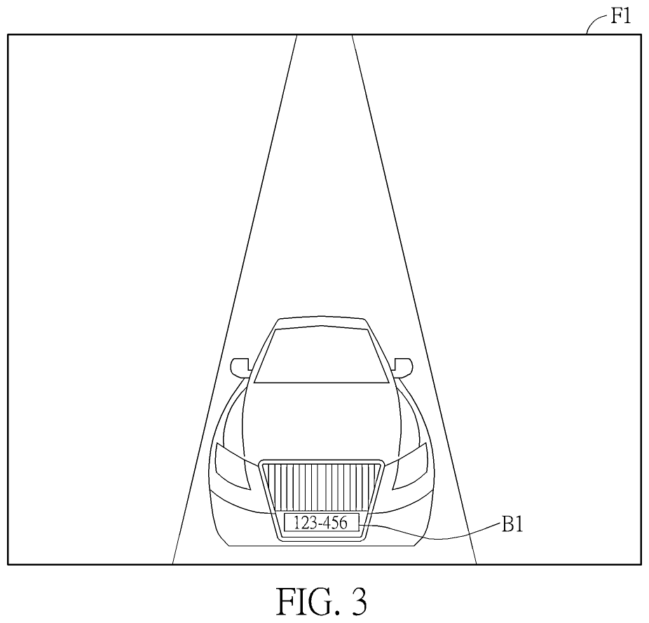

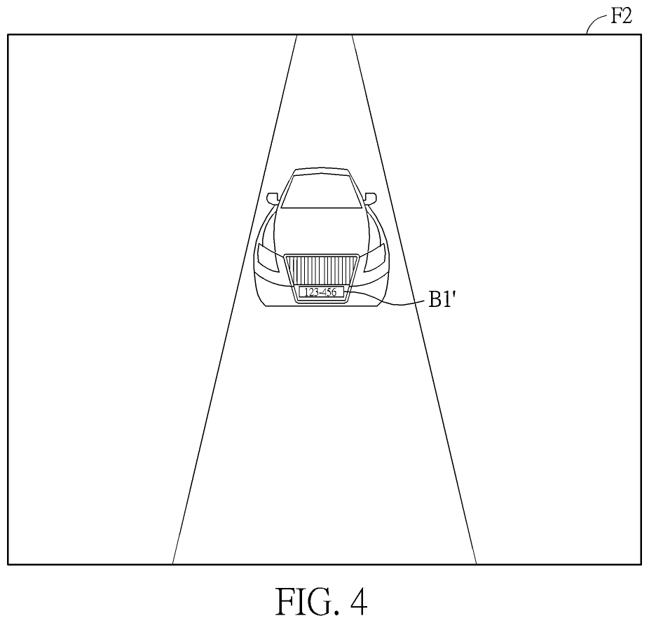

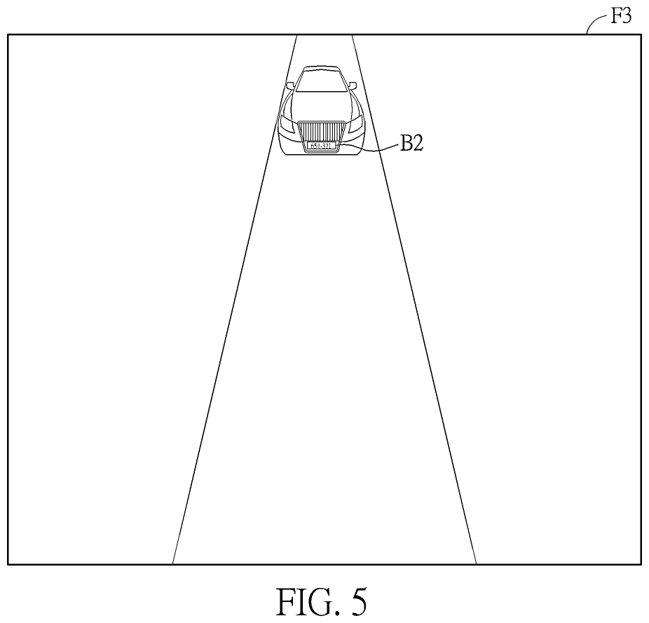

Please refer to FIG. 1 to FIG. 5. FIG. 1 is a functional block diagram of a surveillance apparatus 10 according to a first embodiment of the present invention. FIG. 2 is a flow chart of an image analysis method according to the first embodiment of the present invention. FIG. 3 is a diagram of a first image frame F1 obtained by the surveillance apparatus 10 according to the first embodiment of the present invention. FIG. 4 is a diagram of a second image frame F2 obtained by the surveillance apparatus 10 according to the first embodiment of the present invention. FIG. 5 is a diagram of a third image frame F3 obtained by the surveillance apparatus 10 according to the first embodiment of the present invention. As shown in FIG. 1, the surveillance apparatus 10 includes an image receiver 11 and an operation processor 12. The operation processor 12 is electrically connected to the image receiver 11. Specifically, the surveillance apparatus 10 can be a surveillance camera, and the image receiver 11 can be a camera device having a lens assembly and a light sensing component. The operation processor 12 can be implemented by hardware, firmware, software configuration or a combination thereof. For example, the operation processor 12 can be a central processing unit, an application processor, a microprocessor, etc., or can be realized by application specific integrated circuits (ASIC). However, the present invention is not limited thereto. For example, the surveillance apparatus 10 can be a network host, a cloud server, or the like, which is incapable of capturing images, and the image receiver 11 can be a signal transceiver for receiving at least one video stream generated by an external image capturing apparatus, which is not shown in the figure.

As shown in FIG. 2, the operation processor 12 is configured to execute the image analysis method which includes steps of:
step S1: the operation processor 12 controls the image receiver 11 to obtain a plurality of image frames including the first image frame F1 and the second image frame F2;
step S2: the operation processor 12 takes a first feature block B1 of the first image frame F1 and a first feature block B1′ of the second image frame F2 as training samples for training an image analysis model when the operation processor 12 determines the first feature block B1 of the first image frame F1 meets a preset condition; and
step S3: the operation processor 12 controls the image receiver 11 to obtain the third image frame F3 having a second feature block B2 and further utilizes the image analysis model for analyzing the second feature block B2 to generate an image prediction result.

Detailed description for the aforementioned steps is provided as follows.

In step S1, the operation processor 12 controls the image receiver 11 to obtain the plurality of image frames, wherein the plurality of image frames have their respective first feature blocks, which are corresponding to each other and can have different definition (such as sharpness, clarity, level of detail and/or fidelity). For example, the operation processor 12 can control the image receiver 11 to obtain two image frames by shooting an object, e.g., a car or a human, at two different time points. It should be noticed that, the image frames obtained by the operation processor 12 can have identical or different resolutions. For example, if the image receiver 11 is a camera device or a signal transceiver receiving image signals from an external image capturing apparatus, the image frames obtained by the operation processor 12 can have identical resolutions. Furthermore, if the image receiver 11 is a signal transceiver receiving image signals from several different external image capturing apparatuses, the image frames obtained by the operation processor 12 can have different resolutions. Besides, the first feature blocks of the image frames can correspond to a same object feature, which can be a car license plate, a human biological feature, e.g., a facial feature, or a clothing feature. The image frame having the first feature block B1 and the image frame having the first feature block B1′ can be defined as the first image frame F1 and the second image frame F2, wherein a definition of the first feature block B1 is greater than a definition of the first feature block B1′.

Taking FIG. 3 and FIG. 4 as examples, when the object and the object feature are a car and a car license plate, respectively, there is no apparent boundary between the text and the background of the first feature block B1′ shown in FIG. 4, i.e., the edge of the text “123-456” can be blurry and/or overlapped, and there is an apparent boundary between the text and the background of the first feature block B1 shown in FIG. 3.

Preferably, the image frame shown in FIG. 3 is corresponding to the object, which is close to the surveillance apparatus 10, and can be defined as the first image frame F1, and the image frame shown in FIG. 4 corresponding to the object, which is far away from the surveillance apparatus 10, can be defined as the second image frame F2. Understandably, the definition of the first feature block of the obtained image frame does not have to be greater when the object is closer to the surveillance apparatus 10. In another embodiment, if the definition of the first feature block of the image frame is influenced by ambient light and/or a moving speed of the object and the definition of the first feature block of the image frame corresponding to the object, which is far away from the surveillance apparatus 10, is greater, the image frame corresponding to the object, which is far away from the surveillance apparatus 10, can be defined as the first image frame F1. Besides, in another embodiment, the operation processor 12 can control the image receiver 11 to obtain three or more image frames by shooting the object at a specific frequency within a specific time period, wherein one of the image frames, of which the first feature block has the greatest definition, can be defined as the first image frame F1, and each of the other image frames can be defined as the second image frame.

In step S2, after the operation processor 12 controls the image receiver 11 to obtain the plurality of image frames, the operation processor 12 can take the first feature block B1 of the first image frame F1 and the first feature block B1′ of the second image frame F2 as the training samples for training the image analysis model when the operation processor 12 determines the first feature block B1 of the first image frame F1 meets the preset condition. Preferably, the operation processor 12 is configured to take the first feature block B1 of the first image frame F1 and the first feature block B1′ of the second image frame F2 as the training samples for training the image analysis model when the operation processor 12 determines the definition of the first feature block B1 of the first image frame F1 is greater than a preset threshold. In other words, the preset condition can refer to that the definition of the first feature block B1 of the first image frame F1 is greater than the preset threshold. On the other hand, the operation processor 12 is configured not to take the first feature block B1 of the first image frame F1 and the first feature block B1′ of the second image frame F2 as the training samples for training the image analysis model when the operation processor 12 determines the definition of the first feature block B1 of the first image frame F1 and the definition of the first feature block B1′ of the second image frame F2 are less than or equal to the preset threshold. Specifically, the image analysis model can be a neural network model. However, the present invention is not limited thereto.

Furthermore, in step S3, after completion of training of the image analysis model, the operation processor 12 can control the image receiver 11 to obtain the third image frame F3 having the second feature block B2 and further utilizes the image analysis model for analyzing the second feature block B2 to generate the image prediction result. For example, the operation processor 12 can control the image receiver 11 to obtain the third image frame F3 having the second feature block B2 corresponding to another object feature, e.g., another car license plate, by shooting another object, e.g., another car, and then generate the image prediction result by analyzing the second feature block B2.

It should be noticed that, if the first image frame F1, the second image frame F2 and the third image frame F3 are obtained by the same image receiver 11 or from the same external image capturing apparatus, which is not shown in the figures, the first image frame F1, the second image frame F2 and the third image frame F3 can have identical resolutions. Understandably, the image prediction result can refer to a text recognition result, a number recognition result or a symbol recognition result, e.g., which are in a form of metadata and do not have to be displayed in the third image frame F3, or refer to generation of a third feature block, which is not shown in the figures, based on the second feature block B2, wherein a definition of the third feature block is greater than a definition of the second feature block B2. For example, there is no apparent boundary between the text and the background of the second feature block B2 shown in FIG. 5, i.e., the edge of the text “654-321” can be blurry and/or overlapped, and after generation of the third feature block based on the second feature block B2, there is an apparent boundary between the text and the background of the third feature block. Besides, the image prediction result can take the place of the second feature block B2 for image display or image analysis. Therefore, this embodiment can effectively improve the definition of the second feature block B2 of the third image frame F3 or increase the recognition accuracy of the image analysis.

In addition, understandably, in another embodiment, after generation of the third feature block whose definition is greater than the definition of the second feature block B2, the third feature block can be fused with the third image frame F3 at a position corresponding to the second block feature B2 for naked eye observation or other applications. Besides, the operation processor 12 can further perform image processing on the third feature block according to at least one image information of the second feature block B2, e.g., a viewing angle information, an image size information, an image distortion information and/or an image color information of the second feature block B2, and then fuse the processed third feature block with the third image frame F3 at the position corresponding to the second block feature B2, so as to optimize combination of image fusion.

It should be noticed that, the training sample of the present invention is not limited to the aforementioned embodiment. Other relevant embodiments and figures are described as follows.

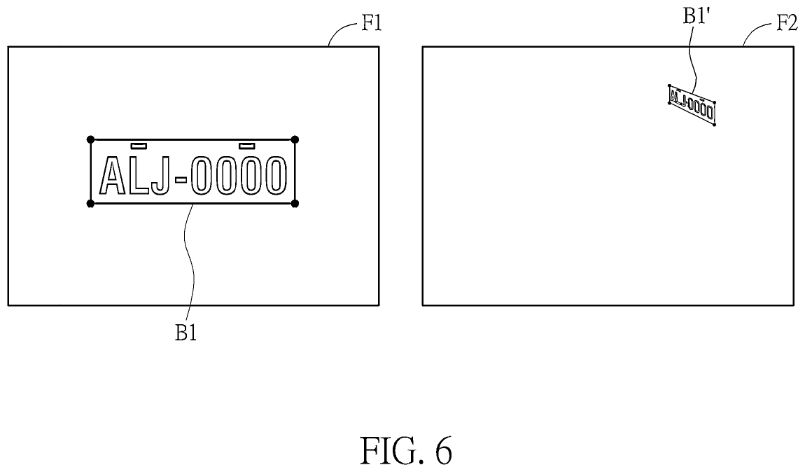

Please refer to FIG. 6. FIG. 6 is a diagram of the first image frame F1 and the second image frame F2 obtained by the surveillance apparatus 10 according to a second embodiment of the present invention. As shown in FIG. 6, in this embodiment, the first image frame F1 and the second image frame F2 include the first feature block B1 and the first feature block B1′, respectively, and in order to save time of generating image prediction result and increase accuracy, the operation processor 12 can perform image processing on the first feature block B1 of the first image frame F1 according to at least one image information of the first feature block B1′ of the second image frame F2, e.g., by distortion correction, affine transformation and/or perspective transformation, and then take the processed first feature block B1 of the first image frame F1 and the first feature block B1′ of the second image frame F2 as the training samples for training the image analysis model.

Preferably, the at least one image information of the first feature block B1′ of the second image frame F2 can include a viewing angle information, an image size information and/or an image distortion information of the first feature block B1′ of the second image frame F2, wherein the viewing angle information can include an pan angle, an tilt angle and/or a roll angle.

Besides, after performing image processing on the first feature block B1 of the first image frame F1 according to at least one image information of the first feature block B1′ of the second image frame F2 by distortion correction, affine transformation and/or perspective transformation, the first feature block B1 can be aligned with the first feature block B1′ of the second image frame F2. Then, the first feature block B1 and the first feature block B1′ aligned with each other can be used as the training samples for training the image analysis model.

Detailed description for alignment of the first feature block B1 and the first feature block B1′ is provided as follows.

The operation processor 12 can determine whether to perform distortion correction on the first feature block B1 and the first feature block B1′ according to the lens/camera intrinsics and a distortion of the first feature block B1 based on a coordinate position of the first feature block B1. For example, the image frame captured by the fisheye lens or camera has significant distortion on edge portions. Afterwards, no matter whether the first feature block B1 is un-distorted by distortion correction or not, the operation processor 12 can further transform the original first feature block B1, which is not un-distorted, or the un-distorted first feature block B1 by affine transformation and/or perspective transformation, so as to generate a first image transformation information, wherein the affine or the perspective transformation can generate an affine or perspective or mixed transform matrix by feature detection and matching or finding vanish point.

Furthermore, the operation processor 12 can adjust a size of the first image transformation information proportionally according to a difference between the size of the first image transformation information and a size of the first feature block B1′, so as to generate a second image transformation information, wherein the second image transformation information keeps a color information of each pixel of the first image transformation information. For example, if the size of the second image transformation information is half of the size of the first image transformation information, e.g., the size of the second image transformation information is 300*200 and the size of the first image transformation information is 600*400, a coordinate position of each pixel of the first image transformation information is adjusted proportionally according to the above size difference to generate a coordinate position of each pixel of the second image transformation information, wherein the coordinate position of the pixel of the second image transformation information may contain a non-integer value.

Afterwards, the operation processor 12 can perform coordinate conversion (mapping or translation) on the second image transformation information based on a coordinate position of the first feature block B1′ of the second image frame F2, and then determine whether to perform distortion correction on the second image transformation information to generate a third image transformation information according to a coordinate position of the original first feature block B1′, which is not un-distorted, and the lens/camera intrinsics. Besides, a size of the third image transformation information, which may be re-distorted or not, can be adjusted to comply with a predetermined size, wherein the predetermined size may be based on a required size of the training sample of the image analysis model. After size adjustment of the third image transformation information, the third image transformation information and the first feature block B1′ can be used as training samples for training the image analysis model.

It should be noticed that a sequence of the coordinate transformation, the re-distortion and the size adjustment can be determined according to practical demands. The un-distortion and re-distortion processes can selectively be executed depending on distortion caused by the lens/camera intrinsics and the coordinate position of the first feature block B1.

In addition, the first feature block B1 of the first image frame F1 after un-distortion, i.e., distortion correction, affine transformation and/or perspective transformation and the first feature block B1′ of the second image frame F2 can have identical resolutions or different resolutions. In this embodiment, the image analysis model can learn characteristics of the lens and/or the light sensing component of the image receiver 11 by the aforementioned method, which can save time of generating image prediction result and avoid inaccuracy of the image prediction result.

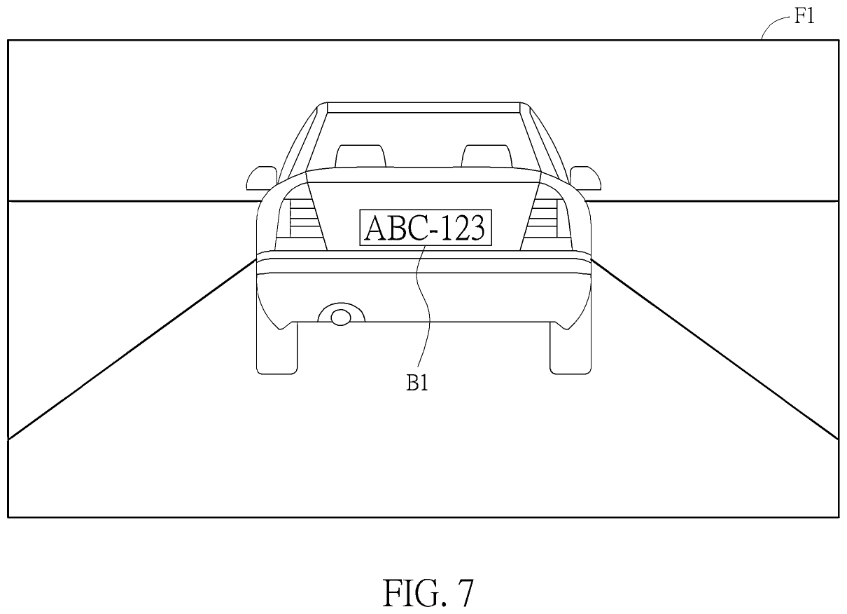

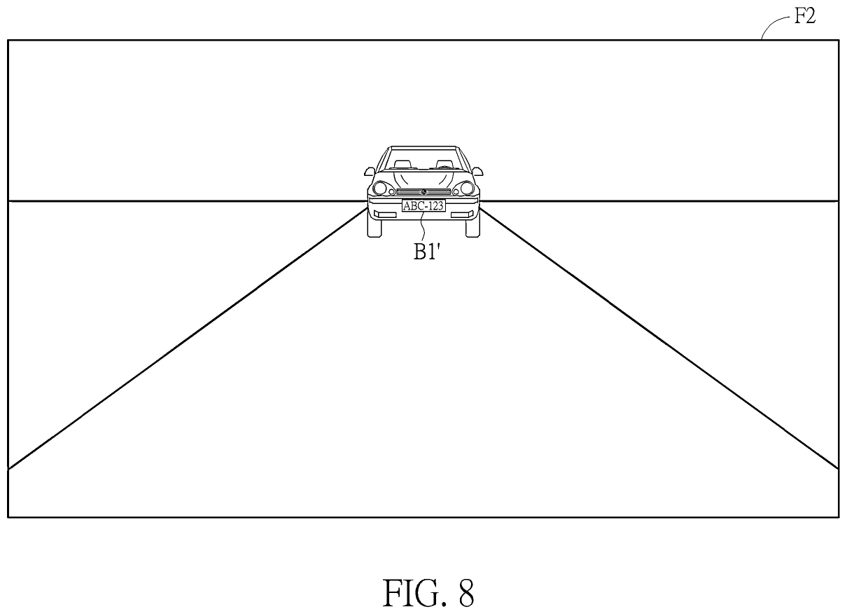

Please refer to FIG. 7 and FIG. 8. FIG. 7 is a diagram of the first image frame F1 obtained by the surveillance apparatus 10 according to a third embodiment of the present invention. FIG. 8 is a diagram of the second image frame F2 obtained by the surveillance apparatus 10 according to the third embodiment of the present invention. As shown in FIG. 7 and FIG. 8, in this embodiment, the first image frame F1 and the second image frame F2 can be two image frames corresponding to a rear car license plate and a front car license plate of a same car, respectively. If a definition of the first feature block B1 of the first image frame corresponding to the rear car license plate is greater than a definition of the first feature block B1′ of the second image frame corresponding to the front car license plate and meet the preset condition, the operation processor 12 can take the first feature block B1 of the first image frame F1 corresponding to the rear car license plate and the first feature block B1′ of the second image frame F2 corresponding to the front car license plate as the training examples for training the image analysis model.

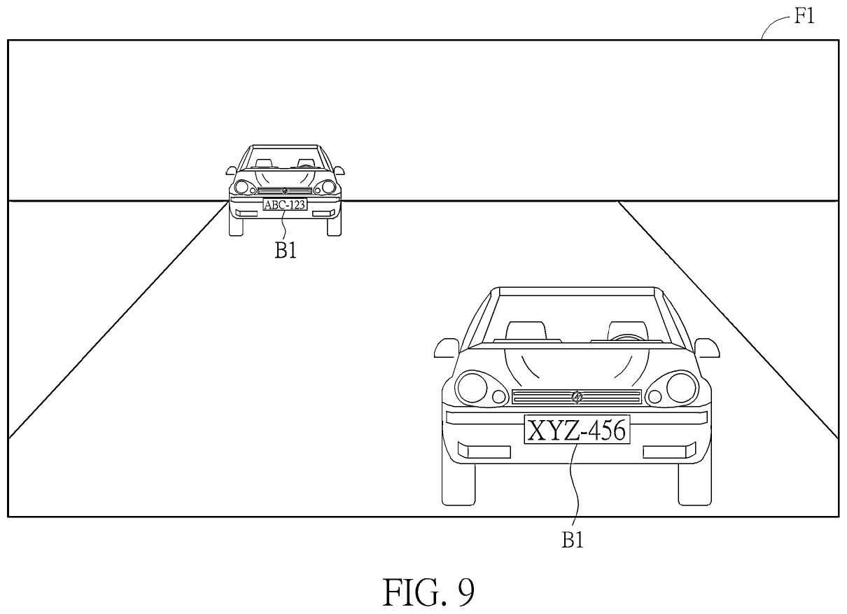

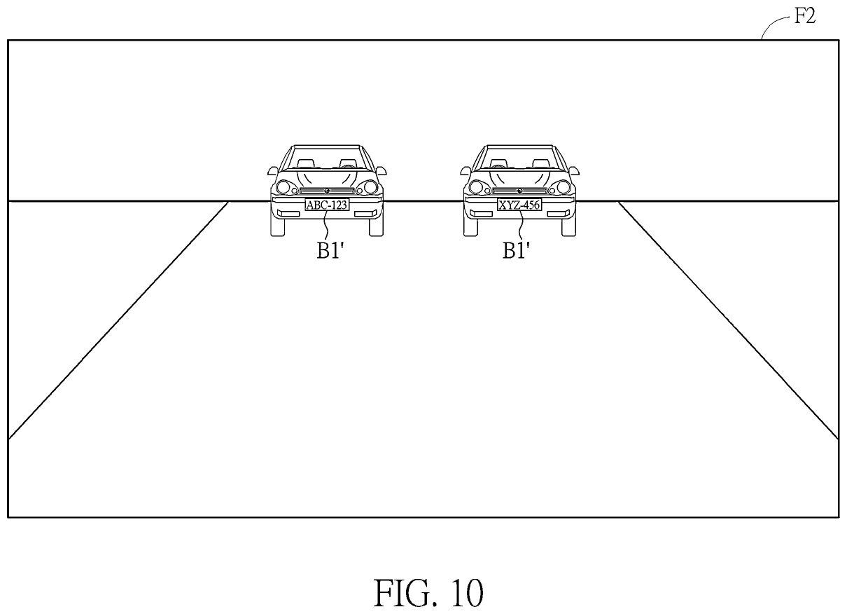

Please refer to FIG. 9 and FIG. 10. FIG. 9 is a diagram of the first image frame F1 obtained by the surveillance apparatus 10 according to a fourth embodiment of the present invention. FIG. 10 is a diagram of the second image frame F2 obtained by the surveillance apparatus 10 according to the fourth embodiment of the present invention. As shown in FIG. 9 and FIG. 10, in this embodiment, the first image frame F1 can include a plurality of first feature blocks B1 corresponding to a plurality of objects, and the second image frame F2 can include a plurality of first feature blocks B1′ corresponding to the same plurality of objects. A definition of a left one of the plurality of first feature blocks B1 of the first image frame F1 does not meet the preset condition, and a definition of a right one of the plurality of first feature block B1 of the first image frame F1 meets the preset condition and is greater than a definition of a corresponding right one of the plurality of first feature blocks B1′ of the second image frame F2. Therefore, the operation processor 12 can take the right first feature block B1 of the first image frame F1 and the right first feature block B1′ of the second image frame F2 as the training examples for training the image analysis model.

In contrast to the prior art, in the present invention, the operation processor can control the image receiver to obtain the first image frame and the second image frame having the respective first feature blocks, and the operation processor can further take the first feature block of the first image frame and the first feature block of the second image frame as the training samples for training the image analysis model when the operation processor determines the first feature block of the first image frame meets the preset condition. Therefore, when an image to be recognized has a low definition, the present invention can generate an accurate recognition result or sharpen the image.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image analysis method performed in a surveillance apparatus comprising an image receiver and an operation processor, the image analysis method comprising:
the operation processor controlling the image receiver to receive a plurality of image frames, wherein the plurality of image frames comprises a first image frame and at least one second image frame, each of the first image frame and the at least one second image frame comprises a first feature block, and a definition of the first feature block of the first image frame is different from a definition of the first feature block of the at least one second image frame; and
the operation processor taking the first feature block of the first image frame and the first feature block of the at least one second image frame as training samples for training an image analysis model when the operation processor determines the first feature block of the first image frame meets a preset condition.

2. The image analysis method of claim 1, wherein the first image frame and the at least one second image frame are generated by capturing a same object at different time points, or by different image capturing apparatuses.

3. The image analysis method of claim 1, wherein the preset condition is that the definition of the first feature block of the first image frame is greater than a preset threshold.

4. The image analysis method of claim 1, wherein the definition of the first feature block of the first image frame is greater than the definition of the first feature block of the at least one second image frame.

5. The image analysis method of claim 1, further comprising:
the operation processor controlling the image receiver to receive a third image frame comprising a second feature block and further utilizing the image analysis model for analyzing the second feature block to generate an image prediction result.

6. The image analysis method of claim 5, wherein the image prediction result is a text recognition result, a number recognition result or a symbol recognition result.

7. The image analysis method of claim 5, wherein the image prediction result refers to generation of a third feature block based on the second feature block, and a definition of the third feature block is greater than a definition of the second feature block.

8. The image analysis method of claim 5, wherein a resolution of the first image frame, a resolution of the at least one second image frame and a resolution of the third image frame are identical to one another.

9. The image analysis method of claim 1, wherein the operation processor taking the first feature block of the first image frame and the first feature block of the at least one second image frame as the training samples for training the image analysis model when the operation processor determines the first feature block of the first image frame meets the preset condition, comprising:
the operation processor performing image processing on the first feature block of the first image frame according to at least one image information of the first feature block of the at least one second image frame, wherein the at least one image information of the first feature block of the at least one second image frame comprises a viewing angle information, an image size information and/or an image distortion information of the first feature block of the at least one second image frame; and
the operation processor taking the processed first feature block of the first image frame and the first feature block of the at least one second feature block as the training samples for training the image analysis model.

10. The image analysis method of claim 1, further comprising:
the operation processor resizing the first feature block of the first image frame proportionally according to a difference between a size of the first feature block of the first image frame and a size of the first feature block of the at least one second image frame, and taking the resized first feature block of the first image frame and the first feature block of the at least one second feature block as the training samples for training the image analysis model.

11. A surveillance apparatus comprising:
an image receiver; and
an operation processor electrically connected to the image receiver;
wherein the operation processor is configured to control the image receiver to obtain a plurality of image frames and further configured to take the first feature block of the first image frame and the first feature block of the at least one second image frame as training samples for training an image analysis model when the operation processor determines the first feature block of the first image frame meets a preset condition;
wherein the plurality of image frames comprises a first image frame and at least one second image frame, each of the first image frame and the at least one second image frame comprises a first feature block, and a definition of the first feature block of the first image frame is different from a definition of the first feature block of the at least one second image frame.

12. The surveillance apparatus of claim 11, wherein the first image frame and the at least one second image frame are obtained from an object at different time points, or by different image capturing apparatuses.

13. The surveillance apparatus of claim 11, wherein the preset condition is that the definition of the first feature block of the first image frame is greater than a preset threshold.

14. The surveillance apparatus of claim 11, wherein the definition of the first feature block of the first image frame is greater than the definition of the first feature block of the at least one second image frame.

15. The surveillance apparatus of claim 11, wherein the operation processor is further configured to control the image receiver to obtain a third image frame comprising a second feature block and further utilize the image analysis model for analyzing the second feature block to generate an image prediction result.

16. The surveillance apparatus of claim 15, wherein the image prediction result refers to a text recognition result, a number recognition result or a symbol recognition result.

17. The surveillance apparatus of claim 15, wherein the image prediction result refers to generating a third feature block based on the second feature block, and a definition of the third feature block is greater than a definition of the second feature block.

18. The surveillance apparatus of claim 15, wherein a resolution of the first image frame, a resolution of the at least one second image frame and a resolution of the third image frame are identical to one another.

19. The surveillance apparatus of claim 11, wherein the operation processor is further configured to perform image processing on the first feature block of the first image frame according to at least one image information of the first feature block of the at least one second image frame and use the processed first feature block of the first image frame and the first feature block of the at least one second feature block as the training samples for training the image analysis model, the at least one image information of the first feature block of the at least one second image frame comprises a viewing angle information, an image size information and/or an image distortion information of the first feature block of the at least one second image frame.

20. The surveillance apparatus of claim 11, wherein the operation processor is further configured to resize the first feature block of the first image frame proportionally according to a difference between a size of the first feature block of the first image frame and a size of the first feature block of the at least one second image frame and use the resized first feature block of the first image frame and the first feature block of the at least one second feature block as the training samples for training the image analysis model.
